(19) United States
(12) Patent Application Publication
(10) Pub. No.: US 2026/0149078 A1
(43) Pub. Date: May 28, 2026

(54) VEHICLE HEAT MANAGEMENT SYSTEM

(71) Applicant: KABUSHIKI KAISHA TOYOTA JIDOSHOKKI, Kariya-shi, Aichi-ken (JP)

(72) Inventor: Hirokuni AKIYAMA, Kariya-shi (JP)

(73) Assignee: KABUSHIKI KAISHA TOYOTA JIDOSHOKKI, Kariya-shi, Aichi-ken (JP)

(21) Appl. No.: 19/121,553

(22) PCT Filed: Sep. 29, 2023
(86) PCT No.: PCT/JP2023/035634

§ 371 Date: Apr. 16, 2025

(30) Foreign Application Priority Data
Oct. 26, 2022 (JP) 2022-171454

(51) Int. Cl. H01M 10/633; B60H 1/00; B60H 1/32; B60L 58/26; B60L 58/27; H01M 10/613

(52) U.S. Cl. CPC H01M 10/633; B60H 1/00278; B60H 1/32281; B60L 58/26; B60L 58/27; H01M 10/613; B60H 2001/00307

(57) ABSTRACT

The vehicle thermal management system includes a controller. The controller is configured to switch an operating mode of the vehicle thermal management system between a battery cooling mode, a battery warm-up mode, and an auxiliary heating mode. In the battery cooling mode, coolant cooled by a second refrigerant at a second heat exchanger absorbs heat from a battery, thereby cooling the battery. In the battery warm-up mode, the coolant that has dissipated heat from the second refrigerant at the second heat exchanger dissipates heat to the battery, thereby warming up the battery. In the auxiliary heating mode, the second refrigerant dissipates heat to the coolant at the second heat exchanger, thereby heating the coolant. Further, the heated coolant dissipates heat to a first refrigerant at the first heat exchanger, thereby heating the first refrigerant.

### TECHNICAL FIELD

The present disclosure relates to a vehicle thermal management system.

### BACKGROUND ART

The vehicle thermal management system includes a refrigerant circuit through which refrigerant circulates to condition the passenger compartment. The vehicle thermal management system further includes a thermal medium circuit through which a thermal medium circulates to regulate the temperature of the battery.

For instance, in environments where the ambient temperature is extremely low (e.g., cold regions), the passenger compartment may not be heated efficiently. Thus, even in environments where the ambient temperature is extremely low, it is desirable to enhance the heating capacity to efficiently heat the passenger compartment. To solve such a problem, known vehicle thermal management systems include a heat exchanger that is coupled to a refrigerant circuit and a thermal medium circuit. The heat exchanger performs heat transfer between the refrigerant flowing through the refrigerant circuit and the thermal medium flowing through the thermal medium circuit. Further, Patent Literature 1 discloses an example of a vehicle thermal management system that includes a heating unit that heats the thermal medium flowing through the thermal medium circuit. In this system, the heating unit heats the thermal medium that flows through the thermal medium circuit, thereby efficiently warming up the battery with the thermal medium. In addition, heat is exchanged between the refrigerant and the thermal medium at the heat exchanger so that the refrigerant is heated by the thermal medium that has been heated by the heating unit. As a result, the heating capacity is improved.

### CITATION LIST

### Patent Literature

Patent Literature 1: Japanese Laid-Open Patent Publication No. 2020-23224

### SUMMARY OF INVENTION

### Technical Problem

However, in Patent Literature 1, for example, when the battery needs to be cooled, the thermal medium cannot be cooled by the heating unit. As a result, the battery temperature cannot be regulated efficiently. Therefore, it is desirable to enhance the heating capacity while efficiently regulating the battery temperature.

### Solution to Problem

A vehicle thermal management system according to an aspect includes a first refrigerant circuit configured such that a first refrigerant circulates through the first refrigerant circuit to condition a passenger compartment, a thermal medium circuit configured such that a thermal medium circulates through the thermal medium circuit to regulate a temperature of a battery, a second refrigerant circuit configured such that a second refrigerant circulates through the second refrigerant circuit to regulate a temperature of the thermal medium, the second refrigerant circuit including a compressor configured to compress and discharge the second refrigerant, an outside air heat exchanger configured to perform heat exchange between the second refrigerant and outside air, and an expansion valve configured to reduce a pressure of the second refrigerant, a first heat exchanger coupled to the first refrigerant circuit and the thermal medium circuit and configured to perform heat exchange between the first refrigerant and the thermal medium, a second heat exchanger coupled to the second refrigerant circuit and the thermal medium circuit and configured to perform heat exchange between the second refrigerant and the thermal medium, and a controller configured to control operation of the first refrigerant circuit, the thermal medium circuit, and the second refrigerant circuit. The second refrigerant circuit includes a direction switching unit configured to switch between a first switching state and a second switching state under control of the controller. The second refrigerant discharged from the compressor flows toward the outside air heat exchanger in the first switching state, and the second refrigerant discharged from the compressor flows toward the second heat exchanger in the second switching state. The controller is configured to switch an operating mode of the vehicle thermal management system between a battery cooling mode, a battery warm-up mode and an auxiliary heating mode. The battery cooling mode switches the direction switching unit to the first switching state so that: the second refrigerant discharged from the compressor dissipates heat to the outside air at the outside air heat exchanger; after the heat dissipation, the second refrigerant is reduced in pressure by the expansion valve and absorbs heat from the thermal medium at the second heat exchanger, thereby cooling the thermal medium; and the cooled thermal medium absorbs heat from the battery to consequently cool the battery. The battery warm-up mode switches the direction switching unit to the second switching state so that: the second refrigerant discharged from the compressor dissipates heat to the thermal medium at the second heat exchanger; after the heat dissipation, the second refrigerant is reduced in pressure by the expansion valve and absorbs heat from the outside air at the outside air heat exchanger; and the heated thermal medium dissipates heat to the battery to consequently warm up the battery. The auxiliary heating mode switches the direction switching unit to the second switching state so that: the second refrigerant discharged from the compressor dissipates heat to the thermal medium at the second heat exchanger to heat the thermal medium; and the heated thermal medium dissipates heat to the first refrigerant at the first heat exchanger to heat the first refrigerant, thereby consequently heating the passenger compartment.

### BRIEF DESCRIPTION OF DRAWINGS

FIG. 1 is a schematic diagram showing a vehicle thermal management system according to an embodiment.

FIG. 2 is a schematic diagram illustrating an example of a battery cooling mode.

FIG. 3 is a schematic diagram illustrating an example of a battery warm-up mode.

FIG. 4 is a schematic diagram illustrating an example of an auxiliary heating mode.

FIG. 5 is a schematic diagram illustrating an example of a radiator heat dissipation mode.

FIG. 6 is a schematic diagram illustrating an example of a drive device heat source mode.

FIG. 7 is a schematic diagram illustrating an example of a modification of the radiator heat dissipation mode.

FIG. 8 is a schematic diagram illustrating an example of a modification of an auxiliary heating mode.

### DESCRIPTION OF EMBODIMENTS

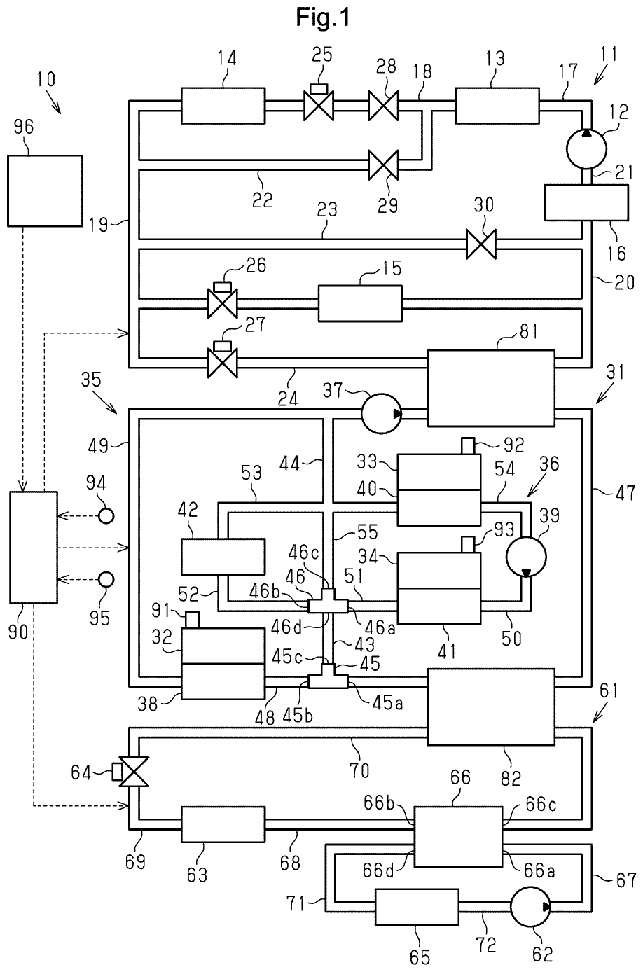

An embodiment of a vehicle thermal management system will now be described with reference to FIGS. 1 to 6. The vehicle thermal management system of the present embodiment is, for example, installed in electric vehicles.

### Overall Configuration of Vehicle Thermal Management System 10

As shown in FIG. 1, the vehicle thermal management system 10 includes a first refrigerant circuit 11, a thermal medium circuit 31, a second refrigerant circuit 61, a first heat exchanger 81, a second heat exchanger 82, and a controller 90.

### First Refrigerant Circuit 11

In the first refrigerant circuit 11 a first refrigerant circulates to condition the passenger compartment. The first refrigerant circuit 11 includes a first compressor 12, a heating indoor heat exchanger 13, a first outdoor heat exchanger 14, a cooling indoor heat exchanger 15, and a first accumulator 16.

The first compressor 12 compresses and discharges the first refrigerant. The heating indoor heat exchanger 13 performs heat exchange between the first refrigerant and indoor air, which is supplied to the passenger compartment. The first outdoor heat exchanger 14 performs heat exchange between the first refrigerant and outside air. The cooling indoor heat exchanger 15 performs heat exchange between the first refrigerant and the indoor air, which is supplied to the passenger compartment. The first accumulator 16 permits the flow of the first refrigerant in a gas state to the first compressor 12 and prevents the flow of the first refrigerant in a liquid state to the first compressor 12.

The first compressor 12 and the heating indoor heat exchanger 13 are connected to each other by a first pipe 17. The first end of the first pipe 17 is connected to the discharge port of the first compressor 12. The second end of the first pipe 17 is connected to the inlet of the heating indoor heat exchanger 13.

The heating indoor heat exchanger 13 and the first outdoor heat exchanger 14 are connected to each other by a second pipe 18. The first end of the second pipe 18 is connected to the outlet of the heating indoor heat exchanger 13. The second end of the second pipe 18 is connected to the inlet of the first outdoor heat exchanger 14.

The first outdoor heat exchanger 14 and the cooling indoor heat exchanger 15 are connected to each other by a third pipe 19. The first end of the third pipe 19 is connected to the outlet of the first outdoor heat exchanger 14. The second end of the third pipe 19 is connected to the inlet of the cooling indoor heat exchanger 15.

The cooling indoor heat exchanger 15 and the first accumulator 16 are connected to each other by a fourth pipe 20. The first end of the fourth pipe 20 is connected to the outlet of the cooling indoor heat exchanger 15. The second end of the fourth pipe 20 is connected to the inlet of the first accumulator 16.

The first accumulator 16 and the first compressor 12 are connected to each other by a fifth pipe 21. The first end of the fifth pipe 21 is connected to the outlet of the first accumulator 16. The second end of the fifth pipe 21 is connected to the suction port of the first compressor 12.

The first refrigerant circuit 11 includes a first branch pipe 22, a second branch pipe 23, and a third branch pipe 24. The first branch pipe 22 connects the second pipe 18 to the third pipe 19. The first end of the first branch pipe 22 is connected to the second pipe 18. The second end of the first branch pipe 22 is connected to the third pipe 19. Therefore, the first branch pipe 22 branches from a certain point of the second pipe 18 and connects to the third pipe 19.

The second branch pipe 23 connects the third pipe 19 to the fourth pipe 20. The first end of the second branch pipe 23 is connected to a portion of the third pipe 19 that is closer to the cooling indoor heat exchanger 15 than to the connection point with the first branch pipe 22. The second end of the second branch pipe 23 is connected to the fourth pipe 20.

Thus, the second branch pipe 23 branches from the portion of the third pipe 19 that is closer to the cooling indoor heat exchanger 15 than to the connection point with the first branch pipe 22, and connects to the fourth pipe 20.

The third branch pipe 24 connects the third pipe 19 and the fourth pipe 20 to each other. The first end of the third branch pipe 24 is connected to a portion of the third pipe 19 that is closer to the cooling indoor heat exchanger 15 than to the connection point with the second branch pipe 23. The second end of the third branch pipe 24 is connected to a portion of the fourth pipe 20 that is closer to the cooling indoor heat exchanger 15 than to the connection point with the second branch pipe 23. Thus, the third branch pipe 24 branches from the portion of the third pipe 19 that is closer to the cooling indoor heat exchanger 15 than to the connection point with the second branch pipe 23, and connects to the portion of the fourth pipe 20 that is closer to the cooling indoor heat exchanger 15 than to the connection point with the second branch pipe 23.

The first refrigerant circuit 11 includes a first variable orifice 25, a second variable orifice 26, and a third variable orifice 27. The first variable orifice 25 is installed in the second pipe 18. The first variable orifice 25 is located at a portion of the second pipe 18 closer to the first outdoor heat exchanger 14 than to the connection point with the first branch pipe 22. The first variable orifice 25 is configured to adjust the cross-sectional flow area of the second pipe 18. The first variable orifice 25 is an electromagnetic valve. The first variable orifice 25 is electrically connected to the controller 90. The controller 90 is configured to adjust the opening degree of the first variable orifice 25 by controlling the operation of the first variable orifice 25. The first variable orifice 25 decreases the cross-sectional flow area of the second pipe 18 to constrict the second pipe 18, thereby reducing the pressure of the first refrigerant flowing through the second pipe 18. Therefore, the first variable orifice 25 serves as a first expansion valve that reduces the pressure of the first refrigerant flowing through the first refrigerant circuit 11.

The second variable orifice 26 is installed in the third pipe 19. The second variable orifice 26 is located at a portion of the third pipe 19 closer to the cooling indoor heat exchanger 15 than to the connection point with the third branch pipe 24. The second variable orifice 26 is configured to adjust the cross-sectional flow area of the third pipe 19. The second variable orifice 26 is an electromagnetic valve. The second variable orifice 26 is electrically connected to the controller 90. The controller 90 is configured to adjust the opening degree of the second variable orifice 26 by controlling the operation of the second variable orifice 26. The second variable orifice 26 decreases the cross-sectional flow area of the third pipe 19 to constrict the third pipe 19, thereby reducing the pressure of the first refrigerant flowing through the third pipe 19. Therefore, the second variable orifice 26 serves as the first expansion valve, which reduces the pressure of the first refrigerant flowing through the first refrigerant circuit 11.

The third variable orifice 27 is installed in the third branch pipe 24. The third variable orifice 27 is configured to adjust the cross-sectional flow area of the third branch pipe 24. The third variable orifice 27 is an electromagnetic valve. The third variable orifice 27 is electrically connected to the controller 90. The controller 90 is configured to adjust the opening degree of the third variable orifice 27 by controlling the operation of the third variable orifice 27. The third variable orifice 27 decreases the cross-sectional flow area of the third branch pipe 24 to constrict the third branch pipe 24, thereby reducing the pressure of the first refrigerant flowing through the third branch pipe 24. Therefore, the third variable orifice 27 serves as the first expansion valve, which reduces the pressure of the first refrigerant flowing through the first refrigerant circuit 11.

The first refrigerant circuit 11 includes a first on-off valve 28, a second on-off valve 29, and a third on-off valve 30. The first on-off valve 28 is installed in the second pipe 18. The first on-off valve 28 is located at the portion of the second pipe 18 closer to the first outdoor heat exchanger 14 than to the connection point with the first branch pipe 22 and closer to the heating indoor heat exchanger 13 than to the first variable orifice 25. The first on-off valve 28 is configured to switch an open state, which permits the flow of the first refrigerant through the second pipe 18, and a closed state, which blocks the flow of the first refrigerant in the second pipe 18. The first on-off valve 28 is an electromagnetic valve. The first on-off valve 28 is electrically connected to the controller 90. The controller 90 is configured to switch the first on-off valve 28 between the open state and the closed state by controlling the operation of the first on-off valve 28.

The second on-off valve 29 is installed in the first branch pipe 22. The second on-off valve 29 is configured to switch between the open state, which permits the flow of the first refrigerant through the first branch pipe 22, and the closed state, which blocks the flow of the first refrigerant in the first branch pipe 22. The second on-off valve 29 is an electromagnetic valve. The second on-off valve 29 is electrically connected to the controller 90. The controller 90 is configured to switch the second on-off valve 29 between the open state and the closed state by controlling the operation of the second on-off valve 29.

The third on-off valve 30 is installed in the second branch pipe 23. The third on-off valve 30 is configured to switch between the open state, which permits the flow of the first refrigerant through the second branch pipe 23, and the closed state, which blocks the flow of the first refrigerant in the second branch pipe 23. The third on-off valve 30 is an electromagnetic valve. The third on-off valve 30 is electrically connected to the controller 90. The controller 90 is configured to switch the third on-off valve 30 between the open state and the closed state by controlling the operation of the third on-off valve 30.

### Thermal Medium Circuit 31

The thermal medium circuit 31 circulates coolant, which acts as a thermal medium, to regulate the temperature of the battery 32. In addition to regulating the temperature of the battery 32, the thermal medium circuit 31 regulates the temperatures of an inverter 33 and a motor generator 34, which are powered by the battery 32. The inverter 33 and the motor generator 34 correspond to a drive device that is powered by the battery 32.

The battery 32 is, for example, a lithium-ion battery or a nickel-metal hydride battery. The inverter 33 controls the operation of the motor generator 34 based on the power supplied from the battery 32. When operated by the inverter 33, the motor generator 34 generates driving force for the traveling of an electric vehicle as an electric motor. During the braking of the electric vehicle, the motor generator 34 generates regenerative electric power as a power generator. The regenerative electric power generated by the motor generator 34 is supplied to the battery 32 via the inverter 33.

The thermal medium circuit 31 includes a first circulation circuit 35 and a second circulation circuit 36. The first circulation circuit 35 includes a first pump 37 and a battery heat exchanger 38. The first pump 37 circulates the coolant flowing through the first circulation circuit 35. The first pump 37 is electrically connected to the controller 90. The controller 90 controls the operation of the first pump 37. The battery heat exchanger 38 is thermally coupled to the battery 32. The battery heat exchanger 38 performs heat exchange between the coolant and the battery 32.

The second circulation circuit 36 includes a second pump 39, an inverter heat exchanger 40, a motor heat exchanger 41, and a radiator 42. The second pump 39 circulates the coolant flowing through the second circulation circuit 36. The second pump 39 is electrically connected to the controller 90. The controller 90 controls the operation of the second pump 39.

The inverter heat exchanger 40 is thermally coupled to the inverter 33. The inverter heat exchanger 40 performs heat exchange between the coolant and the inverter 33. Therefore, the inverter heat exchanger 40 corresponds to a drive device heat exchanger that performs heat exchange between the coolant and the drive device.

The motor heat exchanger 41 is thermally coupled to the motor generator 34. The motor heat exchanger 41 performs heat exchange between the coolant and the motor generator 34. Therefore, the motor heat exchanger 41 corresponds to the drive device heat exchanger, which performs heat exchange between the coolant and the drive device.

The radiator 42 performs heat exchange between the coolant and outside air. Further, the radiator 42 dissipates heat from the coolant.

The thermal medium circuit 31 includes a first connecting passage 43 and a second connecting passage 44, each of which serves as a connecting passage. The first connecting passage 43 and the second connecting passage 44 are pipes. The first connecting passage 43 and the second connecting passage 44 connect the first circulation circuit 35 to the second circulation circuit 36. Therefore, the first circulation circuit 35 and the second circulation circuit 36 are connected in parallel by the first connecting passage 43 and the second connecting passage 44.

The thermal medium circuit 31 includes a first switching valve 45, which serves as a switching valve. The first switching valve 45 includes a first port 45a, a second port 45b, and a third port 45c. The first switching valve 45 is configured to selectively open and close the first port 45a, the second port 45b, and the third port 45c. The first switching valve 45 is a three-way valve that switches the connection between the first port 45a, the second port 45b, and the third port 45c. The first switching valve 45 is an electromagnetic valve. The first switching valve 45 is configured to adjust the opening degree of each of the first port 45a, the second port 45b, and the third port 45c. The first switching valve 45 is electrically connected to the controller 90. The controller 90 controls the operation of the first switching valve 45.

The thermal medium circuit 31 includes a second switching valve 46. The second switching valve 46 includes a fourth port 46a, a fifth port 46b, a sixth port 46c, and a connection port 46d. The second switching valve 46 is selectively open and close the fourth port 46a, the fifth port 46b, and the sixth port 46c. The second switching valve 46 is a three-way valve that switches the connection between the fourth port 46a, the fifth port 46b, and the sixth port 46c. The second switching valve 46 is an electromagnetic valve. The second switching valve 46 is configured to adjust the opening degree of each of the fourth port 46a, the fifth port 46b, and the sixth port 46c. The connection port 46d is constantly open. The second switching valve 46 is electrically connected to the controller 90. The controller 90 controls the operation of the second switching valve 46.

The first pump 37 and the first switching valve 45 are connected to each other by a sixth pipe 47. The first end of the sixth pipe 47 is connected to the discharge port of the first pump 37. The second end of the sixth pipe 47 is connected to the first port 45a of the first switching valve 45.

The first switching valve 45 and the battery heat exchanger 38 are connected to each other by a seventh pipe 48. The first end of the seventh pipe 48 is connected to the second port 45b of the first switching valve 45. The second end of the seventh pipe 48 is connected to the inlet of the battery heat exchanger 38.

The battery heat exchanger 38 and the first pump 37 to each other by an eighth pipe 49. The first end of the eighth pipe 49 is connected to the outlet of the battery heat exchanger 38. The second end of the eighth pipe 49 is connected to the suction port of the first pump 37.

The second pump 39 and the motor heat exchanger 41 are connected to each other by a ninth pipe 50. The first end of the ninth pipe 50 is connected to the discharge port of the second pump 39. The second end of the ninth pipe 50 is connected to the inlet of the motor heat exchanger 41.

The motor heat exchanger 41 and the second switching valve 46 are connected to each other by a tenth pipe 51. The first end of the tenth pipe 51 is connected to the outlet of the motor heat exchanger 41. The second end of the tenth pipe 51 is connected to the fourth port 46a of the second switching valve 46.

The second switching valve 46 and the radiator 42 are connected to each other by an eleventh pipe 52. The first end of the eleventh pipe 52 is connected to the fifth port 46b of the second switching valve 46. The second end of the eleventh pipe 52 is connected to the inlet of the radiator 42.

The radiator 42 and the inverter heat exchanger 40 are connected to each other by a twelfth pipe 53. The first end of the twelfth pipe 53 is connected to the outlet of the radiator 42. The second end of the twelfth pipe 53 is connected to the inlet of the inverter heat exchanger 40.

The inverter heat exchanger 40 and the second pump 39 are connected to each other by a thirteenth pipe 54. The first end of the thirteenth pipe 54 is connected to the outlet of the inverter heat exchanger 40. The second end of the thirteenth pipe 54 is connected to the suction port of the second pump 39.

The second circulation circuit 36 includes a bypass passage 55. The bypass passage 55 is a pipe. The bypass passage 55 connects the second switching valve 46 and the twelfth pipe 53 to each other. The first end of the bypass passage 55 is connected to the sixth port 46c of the second switching valve 46. The second end of the bypass passage 55 is connected to the twelfth pipe 53.

The first connecting passage 43 connects the first switching valve 45 and the second switching valve 46 to each other. The first end of the first connecting passage 43 is connected to the third port 45c of the first switching valve 45. The second end of the first connecting passage 43 is connected to the connection port 46d of the second switching valve 46.

The second connecting passage 44 connects the eighth pipe 49 of the first circulation circuit 35 and the twelfth pipe 53 of the second circulation circuit 36 to each other. The first end of the second connecting passage 44 is connected to a portion of the twelfth pipe 53 corresponding to the connection point with the bypass passage 55. The second end of the second connecting passage 44 is connected to the eighth pipe 49.

Under the control of the controller 90, the first switching valve 45 is configured to switch between a permitted state, which permits the connection between the first circulation circuit 35 and the second circulation circuit 36 through the first connecting passage 43, and a blocked state, which blocks the connection between the first circulation circuit 35 and the second circulation circuit 36 through the first connecting passage 43.

In the permitted state of the first switching valve 45, at least the third port 45c is open. In the blocked state of the first switching valve 45, at least the third port 45c is closed.

### Second Refrigerant Circuit 61

The second refrigerant circuit 61 circulates the second refrigerant to regulate the temperature of the coolant flowing through the thermal medium circuit 31. The second refrigerant circuit 61 includes a second compressor 62, a second outdoor heat exchanger 63, a second expansion valve 64, and a second accumulator 65.

The second compressor 62 is a compressor that compresses and discharges the second refrigerant. The second compressor 62 is a dynamic compressor. Therefore, in the present embodiment, the compression method of the compressor that compresses and discharges the second refrigerant is of the dynamic type. The second outdoor heat exchanger 63 performs heat exchange between the second refrigerant and the outside air. The second expansion valve 64 reduces the pressure of the second refrigerant flowing through the second refrigerant circuit 61. The second accumulator 65 permits the flow of the second refrigerant in a gas state to the second compressor 62 and prevents the flow of the second refrigerant in a liquid state to the second compressor 62.

The second refrigerant circuit 61 includes a direction switching unit 66. The direction switching unit 66 includes a first port 66a, a second port 66b, a third port 66c, and a fourth port 66d. The direction switching unit 66 is a four-way valve that switches the connection between the first port 66a, the second port 66b, the third port 66c, and the fourth port 66d. The direction switching unit 66 is an electromagnetic valve. The direction switching unit 66 is configured to adjust the opening degree of each of the first port 66a, the second port 66b, the third port 66c, and the fourth port 66d. The direction switching unit 66 is electrically connected to the controller 90. The controller 90 controls the operation of the direction switching unit 66.

The second compressor 62 and the direction switching unit 66 are connected to each other by a fourteenth pipe 67. The first end of the fourteenth pipe 67 is connected to the discharge port of the second compressor 62. The second end of the fourteenth pipe 67 is connected to the first port 66a of the direction switching unit 66.

The direction switching unit 66 and the second outdoor heat exchanger 63 are connected to each other by a fifteenth pipe 68. The first end of the fifteenth pipe 68 is connected to the second port 66b of the direction switching unit 66. The second end of the fifteenth pipe 68 is connected to the inlet of the second outdoor heat exchanger 63.

The second outdoor heat exchanger 63 and the second expansion valve 64 are connected to each other by a sixteenth pipe 69. The first end of the sixteenth pipe 69 is connected to the outlet of the second outdoor heat exchanger 63. The second end of the sixteenth pipe 69 is connected to the inlet of the second expansion valve 64.

The second expansion valve 64 and the direction switching unit 66 are connected to each other by a seventeenth pipe 70. The first end of the seventeenth pipe 70 is connected to the outlet of the second expansion valve 64. The second end of the seventeenth pipe 70 is connected to the third port 66c of the direction switching unit 66.

The direction switching unit 66 and the second accumulator 65 are connected to each other by an eighteenth pipe 71. The first end of the eighteenth pipe 71 is connected to the fourth port 66d of the direction switching unit 66. The second end of the eighteenth pipe 71 is connected to the inlet of the second accumulator 65.

The second accumulator 65 and the second compressor 62 are connected to each other by a nineteenth pipe 72. The first end of the nineteenth pipe 72 is connected to the outlet of the second accumulator 65. The second end of the nineteenth pipe 72 is connected to the suction port of the second compressor 62.

### First Heat Exchanger 81

The first heat exchanger 81 is coupled to the third branch pipe 24 of the first refrigerant circuit 11 and the sixth pipe 47 of the first circulation circuit 35. Therefore, the first heat exchanger 81 is coupled to the first refrigerant circuit 11 and the thermal medium circuit 31. The first heat exchanger 81 is coupled to a portion of the third branch pipe 24 that is located closer to the fourth pipe 20 than to the third variable orifice 27. The interior of the first heat exchanger 81 defines part of the third branch pipe 24. Further, the interior of the first heat exchanger 81 defines part of the sixth pipe 47. The first heat exchanger 81 performs heat exchange between the first refrigerant flowing through the third branch pipe 24 and the coolant flowing through the sixth pipe 47. Therefore, the first heat exchanger 81 performs heat exchange between the first refrigerant circulating through the first refrigerant circuit 11 and the coolant circulating through the thermal medium circuit 31.

### Second Heat Exchanger 82

The second heat exchanger 82 is coupled to the seventeenth pipe 70 of the second refrigerant circuit 61 and the sixth pipe 47 of the first circulation circuit 35. Therefore, the second heat exchanger 82 is coupled to the second refrigerant circuit 61 and the thermal medium circuit 31. The first circulation circuit 35 is coupled to the first heat exchanger 81 and the second heat exchanger 82. The second heat exchanger 82 is coupled to a portion of the seventeenth pipe 70 that is located closer to the direction switching unit 66 than to a portion of the seventeenth pipe 70 where the second expansion valve 64 is installed. The interior of the second heat exchanger 82 defines part of the seventeenth pipe 70. The second heat exchanger 82 is coupled to a portion of the sixth pipe 47 that is located closer to the first switching valve 45 than to a portion of the sixth pipe 47 where the first heat exchanger 81 is coupled. The interior of the second heat exchanger 82 defines part of the sixth pipe 47. The second heat exchanger 82 performs heat exchange between the second refrigerant flowing through the seventeenth pipe 70 and the coolant flowing through the sixth pipe 47. Therefore, the second heat exchanger 82 conducts heat exchange between the second refrigerant circulating through the second refrigerant circuit 61 and the coolant circulating through the thermal medium circuit 31.

### First Switching State and Second Switching State of Direction Switching Unit 66

Under the control of the controller 90, the direction switching unit 66 is configured to switch between the first switching state and the second switching state. In the first switching state, the direction switching unit 66 directs, toward the second outdoor heat exchanger 63, the second refrigerant discharged from the second compressor 62. In the first switching state of the direction switching unit 66, the first port 66a is connected to the second port 66b, and the third port 66c is connected to the fourth port 66d. In the second switching state, the direction switching unit 66 directs, toward the second heat exchanger 82, the second refrigerant discharged from the second compressor 62. In the second switching state of the direction switching unit 66, the first port 66a is connected to the third port 66c, and the second port 66b is connected to the fourth port 66d.

### Controller 90

The controller 90 includes a central processing unit (CPU). The controller 90 includes a memory. The memory includes, for example, a read-only memory (ROM) that stores various programs, maps, and the like in advance, and a random-access memory (RAM) that temporarily stores the calculation results and the like of the CPU. The controller 90 includes a timer counter, an input interface, and an output interface.

The vehicle thermal management system 10 includes a battery temperature sensor 91. The battery temperature sensor 91 is configured to detect the temperature of the battery 32. The battery temperature sensor 91 is electrically connected to the controller 90. The detection signal for the temperature of the battery 32, which is detected by the battery temperature sensor 91, is output to the controller 90.

The vehicle thermal management system 10 includes an inverter temperature sensor 92. The inverter temperature sensor 92 is configured to detect the temperature of the inverter 33. The inverter temperature sensor 92 is electrically connected to the controller 90. The detection signal for the temperature of the inverter 33, which is detected by the inverter temperature sensor 92, is output to the controller 90.

The vehicle thermal management system 10 includes a motor temperature sensor 93. The motor temperature sensor 93 is configured to detect the temperature of the motor generator 34. The motor temperature sensor 93 is electrically connected to the controller 90. The detection signal for the temperature of the motor generator 34, which is detected by the motor temperature sensor 93, is output to the controller 90.

The vehicle thermal management system 10 includes an ambient temperature sensor 94. The ambient temperature sensor 94 is configured to detect ambient temperature. The ambient temperature sensor 94 is electrically connected to the controller 90. The detection signal for the ambient temperature, which is detected by the ambient temperature sensor 94, is output to the controller 90.

The vehicle thermal management system 10 includes an indoor temperature sensor 95. The indoor temperature sensor 95 is configured to detect the temperature of the passenger compartment. The indoor temperature sensor 95 is electrically connected to the controller 90. The detection signal for the temperature of the passenger compartment, which is detected by the indoor temperature sensor 95, is output to the controller 90.

The controller 90 stores a control program in advance that controls the operation of the first refrigerant circuit 11, the thermal medium circuit 31, and the second refrigerant circuit 61. Therefore, the controller 90 controls the operation of the first refrigerant circuit 11, the thermal medium circuit 31, and the second refrigerant circuit 61.

The controller 90 stores a program in advance that switches the operation of the first refrigerant circuit 11 between a cooling mode, which cools the passenger compartment, and a heating mode, which heats the passenger compartment. Accordingly, the controller 90 is configured to switch the operation of the first refrigerant circuit 11 between the cooling mode, which cools the passenger compartment, and the heating mode, which heats the passenger compartment.

The controller 90 stores a program in advance that switches the operating mode of the vehicle thermal management system 10 between a battery cooling mode, which cools the battery 32, a battery warm-up mode, which warms up the battery 32, and an auxiliary heating mode, which heats the passenger compartment. Accordingly, the controller 90 is configured to switch the operating mode of the vehicle thermal management system 10 between the battery cooling mode, the battery warm-up mode, and the auxiliary heating mode. The auxiliary heating mode, which is different from the heating mode, is used for heating the passenger compartment.

The controller 90 is electrically connected to an air-conditioning ECU 96 installed in the vehicle. The controller 90 receives a signal for an operation command transmitted from the air-conditioning ECU 96. The controller 90 switches the operating mode of the vehicle thermal management system 10 to any one of the cooling mode, the heating mode, and the auxiliary heating mode based on the operation command received from the air-conditioning ECU 96.

The controller 90 stores a program in advance that cools the passenger compartment in the cooling mode when receiving a signal for the operation command of cooling the passenger compartment from the air-conditioning ECU 96. The controller 90 may receive a signal, from the air-conditioning ECU 96, for the operation command to heat the passenger compartment. In this case, the controller 90 stores in advance a program that heats the passenger compartment in the heating mode when the ambient temperature detected by the ambient temperature sensor 94 is higher than a predetermined temperature. Also, the controller 90 stores in advance a program that heats the passenger compartment in the auxiliary heating mode when the ambient temperature detected by the ambient temperature sensor 94 is less than or equal to the predetermined temperature. The predetermined temperature refers to, for example, −10° C.

The controller 90 stores a program in advance that executes the battery cooling mode when the temperature of the battery 32, which is detected by the battery temperature sensor 91, is greater than a target temperature. The controller 90 further stores a program in advance that executes the battery warm-up mode when the temperature of the battery 32, which is detected by the battery temperature sensor 91, is less than the target temperature.

The controller 90 stores a program in advance that executes a radiator heat dissipation mode when the temperature of the battery 32, which is detected by the battery temperature sensor 91, is higher than the target temperature. The controller 90 further stores a program in advance that executes a drive device heat source mode when the temperature of the battery 32, which is detected by the battery temperature sensor 91, is less than the target temperature.

For example, the temperature of the battery 32, which is detected by the battery temperature sensor 91, may be higher than the target temperature. In this case, the controller 90 stores a program in advance that executes the battery cooling mode when the difference between the target temperature and the temperature of the battery 32, which is detected by the battery temperature sensor 91, is higher than a predetermined threshold. In this case, the controller 90 stores a program in advance that executes the radiator heat dissipation mode when the difference between the target temperature and the temperature of the battery 32, which is detected by the battery temperature sensor 91, is lower than the predetermined threshold.

For example, the temperature of the battery 32, which is detected by the battery temperature sensor 91, may be lower than the target temperature. In this case, the controller 90 stores a program in advance that executes the battery warm-up mode when the difference between the target temperature and the temperature of the battery 32, which is detected by the battery temperature sensor 91, is higher than a predetermined threshold. In this case, the controller 90 stores a program in advance that executes the drive device heat source mode when the difference between the target temperature and the temperature of the battery 32, which is detected by the battery temperature sensor 91, is lower than the predetermined threshold.

The controller 90 controls the operation of the first refrigerant circuit 11, the thermal medium circuit 31, and the second refrigerant circuit 61 such that the temperature of the passenger compartment, which is detected by the indoor temperature sensor 95, reaches a target temperature. The controller 90 controls the operation of the first refrigerant circuit 11, the thermal medium circuit 31, and the second refrigerant circuit 61 such that the temperature of the battery 32, which is detected by the battery temperature sensor 91, reaches a target temperature. The controller 90 controls the operation of the first refrigerant circuit 11, the thermal medium circuit 31, and the second refrigerant circuit 61 such that the temperature of the inverter 33, which is detected by the inverter temperature sensor 92, reaches a target temperature. The controller 90 controls the operation of the first refrigerant circuit 11, the thermal medium circuit 31, and the second refrigerant circuit 61 such that the temperature of the motor generator 34, which is detected by the motor temperature sensor 93, reaches a target temperature.

### Operation of Embodiment

The operation of the present embodiment will now be described.

### Cooling Mode

In the cooling mode, the controller 90 performs control to open the first on-off valve 28, the first variable orifice 25, and the second variable orifice 26. This causes the opening degree of the first variable orifice 25 to be fully open. Therefore, the first variable orifice 25 does not serve as the first expansion valve. The opening degree of the second variable orifice 26 is reduced. Therefore, the second variable orifice 26 serves as the first expansion valve. In the cooling mode, the controller 90 performs control to close the second on-off valve 29, the third on-off valve 30, and the third variable orifice 27.

As a result, the first refrigerant discharged from the first compressor 12 flows in sequence through the first pipe 17, the heating indoor heat exchanger 13, the second pipe 18, the first outdoor heat exchanger 14, the third pipe 19, the cooling indoor heat exchanger 15, the fourth pipe 20, the first accumulator 16, and the fifth pipe 21. In the cooling mode, even when the first refrigerant flows through the heating indoor heat exchanger 13, no heat exchange occurs between the first refrigerant and the outside air at the heating indoor heat exchanger 13.

In the cooling mode, the first refrigerant discharged from the first compressor 12 dissipates heat to the outside air at the first outdoor heat exchanger 14. The first refrigerant, which has dissipated heat to the outside air at the first outdoor heat exchanger 14, is reduced in pressure by the second variable orifice 26. The first refrigerant, which has been reduced in pressure by the second variable orifice 26, absorbs heat from the indoor air at the cooling indoor heat exchanger 15. As a result, the indoor air is cooled. The first refrigerant, which has absorbed heat from the indoor air at the cooling indoor heat exchanger 15, returns to the first compressor 12 through the first accumulator 16.

### Heating Mode

In the heating mode, the controller 90 performs control to open the first on-off valve 28, the first variable orifice 25, and the third on-off valve 30. This reduces the opening degree of the first variable orifice 25. Therefore, the first variable orifice 25 serves as the first expansion valve. In the heating mode, the controller 90 performs control to close the second on-off valve 29, the second variable orifice 26, and the third variable orifice 27.

As a result, the first refrigerant discharged from the first compressor 12 flows in sequence through the first pipe 17, the heating indoor heat exchanger 13, the second pipe 18, the first outdoor heat exchanger 14, the third pipe 19, the second branch pipe 23, the fourth pipe 20, the first accumulator 16, and the fifth pipe 21.

In the heating mode, the first refrigerant discharged from the first compressor 12 dissipates heat to the indoor air at the heating indoor heat exchanger 13. As a result, the indoor air is heated. The first refrigerant, which has dissipated heat to the indoor air at the heating indoor heat exchanger 13, is reduced in pressure by the first variable orifice 25. The first refrigerant, which has been reduced in pressure by the first variable orifice 25, absorbs heat from the outside air at the first outdoor heat exchanger 14. The first refrigerant, which has absorbed heat from the outside air at the first outdoor heat exchanger 14, returns to the first compressor 12 through the first accumulator 16.

### Battery Cooling Mode

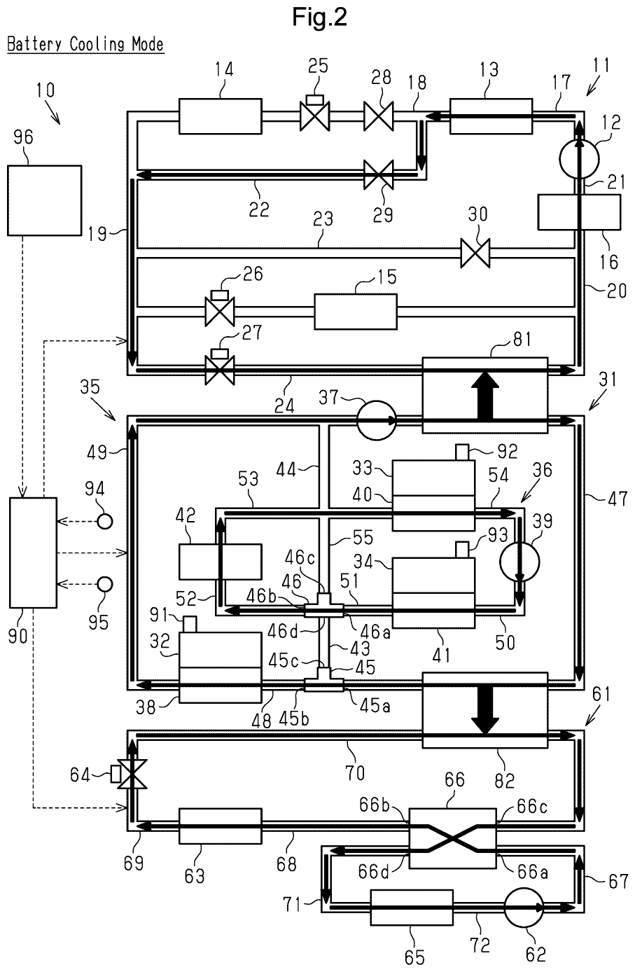

FIG. 2 illustrates the flow of the first refrigerant, the coolant, and the second refrigerant with arrows when the vehicle thermal management system 10 is operating in the battery cooling mode. FIG. 2 further illustrates the movement of heat, depicted with thick arrows, in the first heat exchanger 81 and the second heat exchanger 82 when the vehicle thermal management system 10 is operating in the battery cooling mode. FIG. 2 illustrates an example of the battery cooling mode in the vehicle thermal management system 10.

As shown in FIG. 2, in the battery cooling mode, the controller 90 controls the operation of the direction switching unit 66 so that the direction switching unit 66 is switched to the first switching state. In the battery cooling mode, the direction switching unit 66 connects the first port 66a to the second port 66b, and connects the third port 66c to the fourth port 66d. As a result, the second refrigerant discharged from the second compressor 62 flows in sequence through the fourteenth pipe 67, the fifteenth pipe 68, the second outdoor heat exchanger 63, the sixteenth pipe 69, the second expansion valve 64, the seventeenth pipe 70, the eighteenth pipe 71, the second accumulator 65, and the nineteenth pipe 72.

In the battery cooling mode, the second refrigerant discharged from the second compressor 62 dissipates heat to the outside air at the second outdoor heat exchanger 63. The second refrigerant, which has dissipated heat to the outside air at the second outdoor heat exchanger 63, is reduced in pressure by the second expansion valve 64. The second refrigerant, which has been reduced in pressure by the second expansion valve 64, flows through the seventeenth pipe 70. This causes the second refrigerant to absorb heat from the coolant flowing through the first circulation circuit 35 at the second heat exchanger 82. As a result, the coolant is cooled. The second refrigerant, which has absorbed heat from the coolant in the second heat exchanger 82, returns to the second compressor 62 through the second accumulator 65.

In the battery cooling mode shown in FIG. 2, the controller 90 controls the operation of the first switching valve 45 to open the first port 45a and the second port 45b and close the third port 45c. Therefore, in the vehicle thermal management system 10, during the battery cooling mode shown in FIG. 2, the first switching valve 45 is switched to the blocked state.

In the thermal medium circuit 31 during the battery cooling mode, the first pump 37 is driven under the control of the controller 90. This causes the coolant to circulate through the first circulation circuit 35. The coolant flows out from the first pump 37 into the sixth pipe 47 and is cooled by the second refrigerant in the second heat exchanger 82. Then, the coolant absorbs heat from the battery 32 at the battery heat exchanger 38. Thus, the battery 32 is cooled by the coolant. The coolant, which has absorbed heat from the battery 32, returns to the first pump 37 through the eighth pipe 49.

In the thermal medium circuit 31 during the battery cooling mode shown in FIG. 2, the second pump 39 is driven under the control of the controller 90. This causes the coolant to circulate in the second circulation circuit 36. In the battery cooling mode shown in FIG. 2, the controller 90 controls the operation of the second switching valve 46 to open the fourth port 46a and the fifth port 46b and close the sixth port 46c.

As a result, the coolant supplied to the motor heat exchanger 41 through the ninth pipe 50 from the second pump 39 absorbs heat from the motor generator 34 at the motor heat exchanger 41. As a result, the motor generator 34 is cooled by the coolant. The coolant, which has absorbed heat from the motor generator 34, is supplied to the radiator 42 through the tenth pipe 51, the second switching valve 46, and the eleventh pipe 52. The coolant supplied to the radiator 42 dissipates heat into the outside air at the radiator 42. As a result, the coolant is cooled by the outside air. The coolant, which has been cooled by the outside air at the radiator 42, is supplied to the inverter heat exchanger 40 through the twelfth pipe 53. The coolant supplied to the inverter heat exchanger 40 absorbs heat from the inverter 33 at the inverter heat exchanger 40. As a result, the inverter 33 is cooled by the coolant. The coolant, which has absorbed heat from the inverter 33, returns to the second pump 39 through the thirteenth pipe 54.

In the battery cooling mode shown in FIG. 2, the first switching valve 45 is switched to the blocked state. This blocks the flow of coolant between the first circulation circuit 35 and the second circulation circuit 36 through the first connecting passage 43. Since no coolant flows from the first circulation circuit 35 toward the second circulation circuit 36 through the first connecting passage 43, no coolant flows from the second circulation circuit 36 toward the first circulation circuit 35 through the second connecting passage 44. The temperatures of the battery 32, the inverter 33, and the motor generator 34 are controlled independently.

In the first refrigerant circuit 11 during the battery cooling mode shown in FIG. 2, the controller 90 performs control to open the second on-off valve 29 and the third variable orifice 27. This reduces the opening degree of the third variable orifice 27. Therefore, the third variable orifice 27 serves as the first expansion valve. In the battery cooling mode shown in FIG. 2, the controller 90 performs control to close the first on-off valve 28, the third on-off valve 30, the first variable orifice 25, and the second variable orifice 26.

As a result, the first refrigerant discharged from the first compressor 12 flows in sequence through the first pipe 17, the heating indoor heat exchanger 13, the second pipe 18, the first branch pipe 22, the third pipe 19, the third branch pipe 24, the fourth pipe 20, the first accumulator 16, and the fifth pipe 21.

In the battery cooling mode shown in FIG. 2, the first refrigerant discharged from the first compressor 12 dissipates heat to the indoor air at the heating indoor heat exchanger 13. As a result, the indoor air is heated. The first refrigerant, which has dissipated heat to the indoor air at the heating indoor heat exchanger 13, is reduced in pressure by the third variable orifice 27. The first refrigerant, which has been reduced in pressure by the third variable orifice 27, absorbs heat from the coolant at the first heat exchanger 81. Therefore, in the thermal medium circuit 31, the coolant, which has absorbed heat from the battery 32, dissipates heat to the first refrigerant at the first heat exchanger 81. In this manner, the thermal medium circuit 31 is configured such that the coolant that has absorbed heat from the battery 32 dissipates heat to the first refrigerant at the first heat exchanger 81. The first refrigerant, which has absorbed heat from the coolant at the first heat exchanger 81, returns to the first compressor 12 through the first accumulator 16.

In the battery cooling mode, the direction switching unit 66 is switched to the first switching state so that the second refrigerant discharged from the second compressor 62 dissipates heat to the outside air at the second outdoor heat exchanger 63. After the heat dissipation, the second refrigerant is reduced in pressure by the second expansion valve 64, and absorbs heat from the coolant at the second heat exchanger 82. As a result, the coolant is cooled by the second refrigerant. Consequently, in the battery cooling mode, the cooled coolant absorbs heat from the battery 32, thereby cooling the battery 32.

### Battery Warm-up Mode

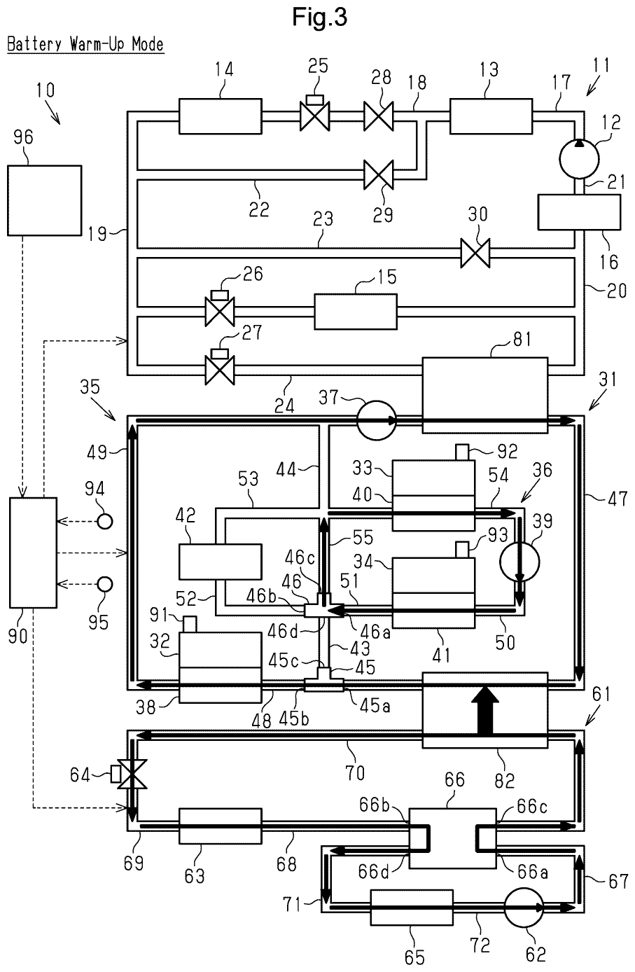

FIG. 3 illustrates the flow of the coolant and the second refrigerant with arrows when the vehicle thermal management system 10 is operating in the battery warm-up mode. FIG. 3 further illustrates the movement of heat, depicted with thick arrows, in the second heat exchanger 82 when the vehicle thermal management system 10 is operating in the battery warm-up mode. FIG. 3 illustrates an example of the battery warm-up mode in the vehicle thermal management system 10.

As shown in FIG. 3, in the battery warm-up mode, the controller 90 controls the operation of the direction switching unit 66 so that the direction switching unit 66 is switched to the second switching state. In the battery warm-up mode, the direction switching unit 66 connects the first port 66a to the third port 66c, and connects the second port 66b to the fourth port 66d. As a result, the second refrigerant discharged from the second compressor 62 flows sequentially through the fourteenth pipe 67, the seventeenth pipe 70, the second expansion valve 64, the sixteenth pipe 69, the second outdoor heat exchanger 63, the fifteenth pipe 68, the eighteenth pipe 71, the second accumulator 65, and the nineteenth pipe 72.

In the battery warm-up mode, the second refrigerant discharged from the second compressor 62 flows through the seventeenth pipe 70. This causes the second refrigerant to dissipate heat to the coolant flowing through the first circulation circuit 35 at the second heat exchanger 82. As a result, the coolant is heated. The second refrigerant, which has dissipated heat to the coolant at the second heat exchanger 82, is reduced in pressure by the second expansion valve 64. The second refrigerant, which has been reduced in pressure by the second expansion valve 64, absorbs heat from the outside air at the second outdoor heat exchanger 63. The second refrigerant, which has absorbed heat from the outside air at the second outdoor heat exchanger 63, returns to the second compressor 62 through the second accumulator 65.

In the battery warm-up mode shown in FIG. 3, the controller 90 controls the operation of the first switching valve 45 to open the first port 45a and the second port 45b and close the third port 45c. Therefore, in the vehicle thermal management system 10, during the battery warm-up mode shown in FIG. 3, the first switching valve 45 is switched to the blocked state. Thus, in the vehicle thermal management system 10, in at least one of the battery cooling mode and the battery warm-up mode, the first switching valve 45 is switched to the blocked state.

In the thermal medium circuit 31 during the battery warm-up mode, the first pump 37 is driven under the control of the controller 90. This causes the coolant to circulate through the first circulation circuit 35. The coolant, which has been heated by the second refrigerant at the second heat exchanger 82, dissipates heat to the battery 32 at the battery heat exchanger 38. As a result, the battery 32 is warmed up by the coolant. The coolant, which has dissipated heat to the battery 32, returns to the first pump 37 through the eighth pipe 49.

In the battery warm-up mode, the direction switching unit 66 is switched to the second switching state so that the second refrigerant discharged from the second compressor 62 dissipates heat to the coolant at the second heat exchanger 82. After the heat dissipation, the second refrigerant is reduced in pressure by the second expansion valve 64, and absorbs heat from the outside air at the second outdoor heat exchanger 63. In the battery warm-up mode, the heated coolant dissipates heat to the battery 32, thereby warming up the battery 32.

In the thermal medium circuit 31 during the battery warm-up mode shown in FIG. 3, the second pump 39 is driven under the control of the controller 90. This causes the coolant to circulate in the second circulation circuit 36. In the battery warm-up mode shown in FIG. 3, the controller 90 controls the operation of the second switching valve 46 to open the fourth port 46a and the sixth port 46c and close the fifth port 46b.

As a result, the coolant from the second pump 39 flows sequentially through the ninth pipe 50, the motor heat exchanger 41, the tenth pipe 51, the second switching valve 46, the bypass passage 55, the twelfth pipe 53, the inverter heat exchanger 40, and the thirteenth pipe 54. Therefore, the coolant flowing through the second circulation circuit 36 circulates through the second circulation circuit 36 while bypassing the radiator 42. Thus, the coolant circulating through the second circulation circuit 36 does not dissipate heat to the outside air at the radiator 42. As a result, the coolant circulating through the second circulation circuit 36 absorbs almost no heat from the motor generator 34 at the motor heat exchanger 41. Further, the coolant absorbs almost no heat from the inverter 33 at the inverter heat exchanger 40 while circulating through the second circulation circuit 36.

In the battery warm-up mode shown in FIG. 3, the first switching valve 45 is switched to the blocked state. This blocks the flow of coolant between the first circulation circuit 35 and the second circulation circuit 36 through the first connecting passage 43. Since no coolant flows from the first circulation circuit 35 toward the second circulation circuit 36 through the first connecting passage 43, no coolant flows from the second circulation circuit 36 toward the first circulation circuit 35 through the second connecting passage 44. The temperatures of the battery 32, the inverter 33, and the motor generator 34 are controlled independently.

In the battery warm-up mode shown in FIG. 3, the first compressor 12 is not operating. Therefore, in the battery warm-up mode shown in FIG. 3, the first refrigerant circuit 11 is not operating. Therefore, in the battery warm-up mode shown in FIG. 3, the vehicle thermal management system 10 does not condition the passenger compartment via the first refrigerant circuit 11.

### Auxiliary Heating Mode

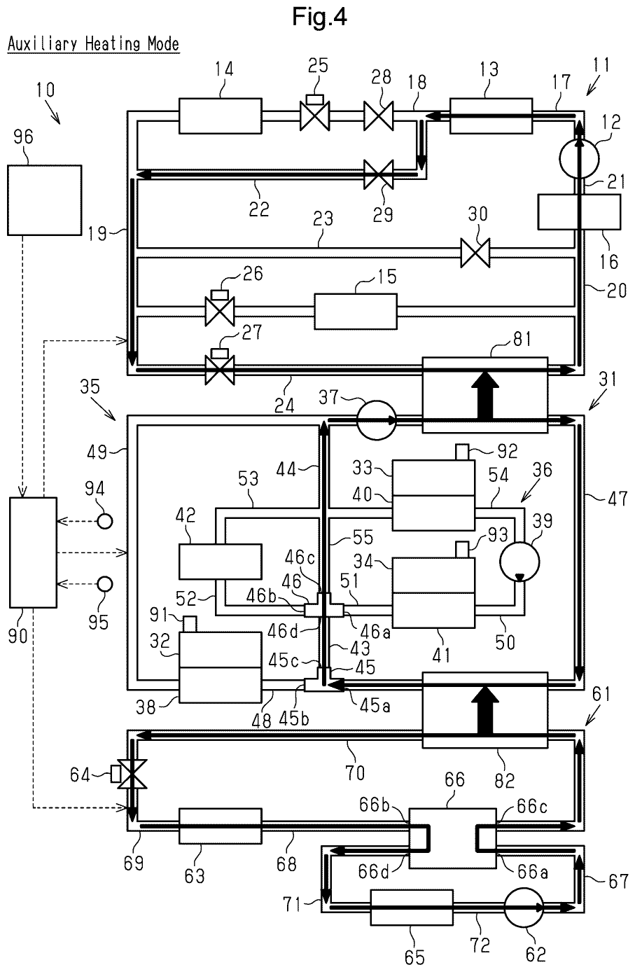

FIG. 4 illustrates the flow of the first refrigerant, the coolant, and the second refrigerant with arrows when the vehicle thermal management system 10 is operating in the auxiliary heating mode. FIG. 4 further illustrates the movement of heat, depicted with thick arrows, in the first heat exchanger 81 and the second heat exchanger 82 when the vehicle thermal management system 10 is operating in the auxiliary heating mode. FIG. 4 illustrates an example of the auxiliary heating mode in the vehicle thermal management system 10.

As shown in FIG. 4, in the auxiliary heating mode, the controller 90 controls the operation of the direction switching unit 66 so that the direction switching unit 66 is switched to the second switching state. In the auxiliary heating mode, the direction switching unit 66 connects the first port 66a to the third port 66c, and connects the second port 66b to the fourth port 66d. As a result, the second refrigerant discharged from the second compressor 62 flows sequentially through the fourteenth pipe 67, the seventeenth pipe 70, the second expansion valve 64, the sixteenth pipe 69, the second outdoor heat exchanger 63, the fifteenth pipe 68, the eighteenth pipe 71, the second accumulator 65, and the nineteenth pipe 72.

In the auxiliary heating mode, the second refrigerant discharged from the second compressor 62 flows through the seventeenth pipe 70. This causes the second refrigerant to dissipate heat to the coolant flowing through the first circulation circuit 35 at the second heat exchanger 82. As a result, the coolant is heated. The second refrigerant, which has dissipated heat to the coolant at the second heat exchanger 82, is reduced in pressure by the second expansion valve 64. The second refrigerant, which has been reduced in pressure by the second expansion valve 64, absorbs heat from the outside air at the second outdoor heat exchanger 63. The second refrigerant, which has absorbed heat from the outside air at the second outdoor heat exchanger 63, returns to the second compressor 62 through the second accumulator 65.

In the auxiliary heating mode shown in FIG. 4, the controller 90 controls the operation of the first switching valve 45 to open the first port 45a and the third port 45c and close the second port 45b. Further, in the auxiliary heating mode shown in FIG. 4, the controller 90 controls the operation of the second switching valve 46 to open the sixth port 46c and close the fourth port 46a and the fifth port 46b.

In the thermal medium circuit 31 during the auxiliary heating mode, the first pump 37 is driven under the control of the controller 90. This causes the coolant to circulate through the first circulation circuit 35. In the auxiliary heating mode shown in FIG. 4, the second pump 39 is not operating. Therefore, the coolant from the first pump 37 flows sequentially through the sixth pipe 47, the first switching valve 45, the first connecting passage 43, the second switching valve 46, the bypass passage 55, the second connecting passage 44, and the eighth pipe 49. Accordingly, the coolant circulating through the first circulation circuit 35 flows through the first circulation circuit 35 while bypassing the battery heat exchanger 38. Thus, the coolant circulating through the first circulation circuit 35 does not undergo heat exchange with the battery 32 at the battery heat exchanger 38.

In the first refrigerant circuit 11 during the auxiliary heating mode, the controller 90 performs control to open the second on-off valve 29 and the third variable orifice 27. This reduces the opening degree of the third variable orifice 27. Therefore, the third variable orifice 27 serves as the first expansion valve. In the auxiliary heating mode, the controller 90 performs control to close the first on-off valve 28, the third on-off valve 30, the first variable orifice 25, and the second variable orifice 26.

As a result, the first refrigerant discharged from the first compressor 12 flows in sequence through the first pipe 17, the heating indoor heat exchanger 13, the second pipe 18, the first branch pipe 22, the third pipe 19, the third branch pipe 24, the fourth pipe 20, the first accumulator 16, and the fifth pipe 21.

In the auxiliary heating mode, the first refrigerant discharged from the first compressor 12 dissipates heat to the indoor air at the heating indoor heat exchanger 13. As a result, the indoor air is heated. The first refrigerant, which has dissipated heat to the indoor air at the heating indoor heat exchanger 13, is reduced in pressure by the third variable orifice 27. The first refrigerant, which has been reduced in pressure by the third variable orifice 27, absorbs heat from the coolant at the first heat exchanger 81. The coolant, which has been warmed up by the second refrigerant at the second heat exchanger 82, dissipates heat to the first refrigerant at the first heat exchanger 81. As a result, the first refrigerant is heated by the coolant. The first refrigerant, which has absorbed heat from the coolant at the first heat exchanger 81, returns to the first compressor 12 through the first accumulator 16.

In the auxiliary heating mode, the second refrigerant dissipates heat to the coolant at the second heat exchanger 82, thereby warming the coolant. Further, the warmed coolant dissipates heat to the first refrigerant at the first heat exchanger 81, thereby warming the first refrigerant. As a result, the heating capacity is improved.

Thus, in the auxiliary heating mode, the direction switching unit 66 is switched to the second switching state so that the second refrigerant discharged from the second compressor 62 dissipates heat to the coolant at the second heat exchanger 82, thereby heating the coolant. Further, in the auxiliary heating mode, the coolant heated by the second refrigerant at the second heat exchanger 82 dissipates heat to the first refrigerant at the first heat exchanger 81, thereby heating the first refrigerant and heating the passenger compartment.

### Radiator Heat Dissipation Mode

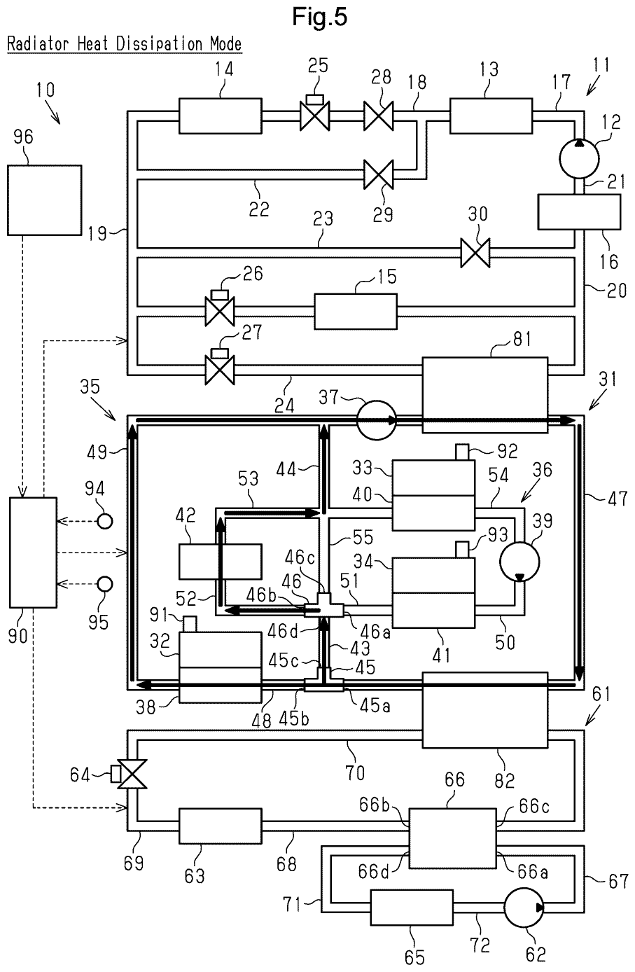

FIG. 5 illustrates the flow of the coolant with arrows when the vehicle thermal management system 10 is operating in the radiator heat dissipation mode. FIG. 5 illustrates an example of the radiator heat dissipation mode in the vehicle thermal management system 10. In the radiator heat dissipation mode shown in FIG. 5, the first compressor 12 and the second compressor 62 are not operating. Therefore, in the radiator heat dissipation mode shown in FIG. 5, the first refrigerant circuit 11 and the second refrigerant circuit 61 are not operating. Thus, in the radiator heat dissipation mode shown in FIG. 5, the vehicle thermal management system 10 does not condition the passenger compartment via the first refrigerant circuit 11.

As shown in FIG. 5, in the radiator heat dissipation mode, the controller 90 controls the operation of the first switching valve 45 to open the first port 45a, the second port 45b, and the third port 45c. Thus, in the radiator heat dissipation mode, the first switching valve 45 is switched to the permitted state. In the radiator heat dissipation mode, the first pump 37 is operated under the control of the controller 90. This causes the coolant to circulate through the first circulation circuit 35.

In the radiator heat dissipation mode shown in FIG. 5, the controller 90 controls the operation of the second switching valve 46 to open the fifth port 46b and close the fourth port 46a and the sixth port 46c. Further, in the radiator heat dissipation mode shown in FIG. 5, the second pump 39 is not operating. Thus, in the second circulation circuit 36, no coolant flows through the inverter heat exchanger 40, the thirteenth pipe 54, the ninth pipe 50, the motor heat exchanger 41, and the tenth pipe 51.

The coolant from the first pump 37 flows from the sixth pipe 47 to the first switching valve 45. In the first switching valve 45, some of the coolant flows into the battery heat exchanger 38 through the seventh pipe 48. In the first switching valve 45, the coolant, which has flowed into the battery heat exchanger 38 through the seventh pipe 48, absorbs heat from the battery 32 at the battery heat exchanger 38. Thus, the battery 32 is cooled by the coolant. The coolant, which has absorbed heat from the battery 32, returns to the first pump 37 through the eighth pipe 49.

Additionally, the coolant from the first pump 37 flows from the sixth pipe 47 to the first switching valve 45. In the first switching valve 45, some of the coolant flows into the second switching valve 46 through the first connecting passage 43. The coolant, which has flowed into the second switching valve 46, flows through the eleventh pipe 52 to the radiator 42. In the radiator 42, the coolant dissipates heat to the outside air. As a result, the coolant is cooled by the outside air. The coolant, which has been cooled by the outside air at the radiator 42, returns to the first pump 37 through the twelfth pipe 53, the second connecting passage 44, and the eighth pipe 49.

Thus, the first switching valve 45 is configured to switch to a radiator connection state. In the radiator connection state, the first switching valve 45 is connected to the radiator 42 and is not connected to the second pump 39, the inverter heat exchanger 40, or the motor heat exchanger 41 in the permitted state. Further, in the radiator heat dissipation mode shown in FIG. 5, the first switching valve 45 is set to the radiator connection state.

Thus, the vehicle thermal management system 10 is configured such that, by switching the first switching valve 45 to the permitted state, the coolant that has absorbed heat from the battery 32 at the battery heat exchanger 38 flows into the second circulation circuit 36 through the first connecting passage 43 and dissipates heat at the radiator 42. Accordingly, the coolant that has absorbed heat from the battery 32 efficiently dissipates heat. As a result, the battery 32 is cooled more efficiently.

### Drive Device Heat Source Mode

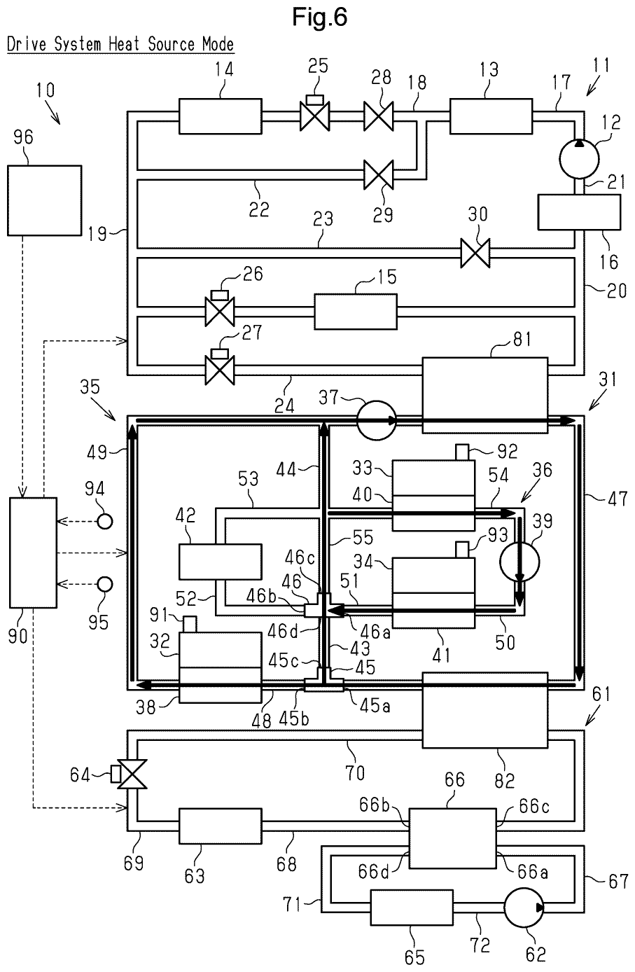

FIG. 6 illustrates the flow of the coolant with arrows when the vehicle thermal management system 10 is operating in the drive device heat source mode. FIG. 6 illustrates an example of the drive device heat source mode in the vehicle thermal management system 10. In the drive device heat source mode shown in FIG. 6, the first compressor 12 and the second compressor 62 are not operating. Therefore, in the drive device heat source mode shown in FIG. 6, the first refrigerant circuit 11 and the second refrigerant circuit 61 are not operating. Therefore, in the drive device heat source mode shown in FIG. 6, the vehicle thermal management system 10 does not condition the passenger compartment via the first refrigerant circuit 11.

As shown in FIG. 6, in the drive device heat source mode, the controller 90 controls the operation of the first switching valve 45 to open the first port 45a, the second port 45b, and the third port 45c. Thus, in the drive device heat source mode, the first switching valve 45 is switched to the permitted state. In the drive device heat source mode, the first pump 37 is operated under the control of the controller 90. This causes the coolant to circulate through the first circulation circuit 35.

In the drive device heat source mode shown in FIG. 6, the controller 90 controls the operation of the second switching valve 46 to open the fourth port 46a and the sixth port 46c and close the fifth port 46b. In the drive device heat source mode, the second pump 39 is operated under the control of the controller 90. Therefore, in the second circulation circuit 36, the coolant from the second pump 39 flows into the twelfth pipe 53 through the ninth pipe 50, the motor heat exchanger 41, the tenth pipe 51, the second switching valve 46, and the bypass passage 55. Then, some of the coolant that has flowed into the twelfth pipe 53 flows into the inverter heat exchanger 40. The coolant, which has flowed into the inverter heat exchanger 40, returns to the second pump 39 through the thirteenth pipe 54.

In the drive device heat source mode, the coolant flowing through the motor heat exchanger 41 absorbs heat from the motor generator 34 at the motor heat exchanger 41. As a result, the motor generator 34 is cooled by the coolant. In the drive device heat source mode, the coolant flowing through the inverter heat exchanger 40 absorbs heat from the inverter 33 at the inverter heat exchanger 40. As a result, the inverter 33 is cooled by the coolant.

In the drive device heat source mode, the coolant from the first pump 37 flows from the sixth pipe 47 to the first switching valve 45. In the first switching valve 45, some of the coolant flows into the second switching valve 46 through the first connecting passage 43. The coolant, which has flowed into the second switching valve 46, is flowed to the twelfth pipe 53 through the bypass passage 55. Accordingly, the coolant flowing through the second circulation circuit 36 flows out to the eighth pipe 49 through the second connecting passage 44, by an amount corresponding to the amount of the coolant flowing from the first circulation circuit 35 to the second circulation circuit 36 through the first connecting passage 43. Therefore, in the drive device heat source mode, the coolant absorbs heat from the motor generator 34 at the motor heat exchanger 41 and also absorbs heat from the inverter 33 at the inverter heat exchanger 40. The coolant then flows to the first circulation circuit 35 through the second connecting passage 44.

In the drive device heat source mode, the coolant from the first pump 37 flows from the sixth pipe 47 to the first switching valve 45. In the first switching valve 45, some of the coolant flows into the battery heat exchanger 38 through the seventh pipe 48. In the first switching valve 45, the coolant, which has flowed into the battery heat exchanger 38 through the seventh pipe 48, dissipates heat to the battery 32 at the battery heat exchanger 38. As a result, the battery 32 is warmed up by the coolant. The coolant, which has dissipated heat to the battery 32, returns to the first pump 37 through the eighth pipe 49.

Thus, in the drive device heat source mode, the first switching valve 45 is switched to the permitted state. As a result, the coolant absorbs heat from the motor generator 34 at the motor heat exchanger 41 and also absorbs heat from the inverter 33 at the inverter heat exchanger 40. The coolant then flows into the first circulation circuit 35 through the second connecting passage 44. The vehicle thermal management system 10 is configured such that the coolant flowing from the second circulation circuit 36 to the first circulation circuit 35 through the second connecting passage 44 dissipates heat to the battery 32 through the battery heat exchanger 38. In this configuration, the coolant absorbs heat from the motor generator 34 at the motor heat exchanger 41 and absorbs heat from the inverter 33 at the inverter heat exchanger 40. Then, the heated coolant dissipates heat to the battery 32 at the battery heat exchanger 38. Consequently, the battery 32 is warmed up more efficiently.

### Advantages of Embodiment

The above-described embodiment provides the following advantages.

(1) In the battery cooling mode, the coolant cooled by the second refrigerant at the second heat exchanger 82 absorbs heat from the battery 32, thereby cooling the battery 32. In the battery warm-up mode, the coolant that has dissipated heat from the second refrigerant at the second heat exchanger 82 dissipates heat to the battery 32, thereby warming up the battery 32. In the auxiliary heating mode, the second refrigerant dissipates heat to the coolant at the second heat exchanger 82, thereby heating the coolant. Further, the heated coolant dissipates heat to the first refrigerant at the first heat exchanger 81, thereby heating the first refrigerant. Thus, the heating capacity of the passenger compartment is improved. This enhances the heating capacity while efficiently regulating the temperature of the battery 32.

(2) Under the control of the controller 90, the first switching valve 45 is set to the permitted state, thereby permitting the flow of coolant between the first circulation circuit 35 and the second circulation circuit 36 through the first connecting passage 43. This allows the temperatures of the battery 32, the inverter 33, and the motor generator 34 to be regulated collectively. Under the control of the controller 90, the first switching valve 45 is set to the blocked state, thereby blocking the flow of coolant between the first circulation circuit 35 and the second circulation circuit 36 through the first connecting passage 43. This allows the temperatures of the battery 32, the inverter 33, and the motor generator 34 to be regulated independently.

(3) The thermal medium circuit 31 is configured set such that the coolant that has absorbed heat from the battery 32 dissipates heat to the first refrigerant at the first heat exchanger 81. This allows the coolant that has absorbed heat from the battery 32 to efficiently dissipate the heat. Thus, the battery 32 is cooled more efficiently.

(4) The vehicle thermal management system 10 is configured such that, by switching the first switching valve 45 to the permitted state, the coolant that has absorbed heat from the battery 32 at the battery heat exchanger 38 flows into the second circulation circuit 36 through the first connecting passage 43 and dissipates heat at the radiator 42. This allows the coolant that has absorbed heat from the battery 32 to efficiently dissipate the heat. Thus, the battery 32 is cooled more efficiently.

(5) Switching the first switching valve 45 to the permitted state causes the coolant that has absorbed heat from the motor generator 34 at the motor heat exchanger 41 and has absorbed heat from the inverter 33 at the inverter heat exchanger 40 to flow into the first circulation circuit 35 through the second connecting passage 44. The vehicle thermal management system 10 is configured such that the coolant flowing from the second circulation circuit 36 to the first circulation circuit 35 through the second connecting passage 44 dissipates heat to the battery 32 through the battery heat exchanger 38. In this configuration, the coolant absorbs heat from the motor generator 34 at the motor heat exchanger 41 and absorbs heat from the inverter 33 at the inverter heat exchanger 40. Then, the heated coolant dissipates heat to the battery 32 at the battery heat exchanger 38. As a result, the battery 32 is warmed up more efficiently.

(6) In at least one of the battery cooling mode and the battery warm-up mode, the controller 90 switches the first switching valve 45 to the blocked state, thereby independently regulating the temperatures of the battery 32, the inverter 33, and the motor generator 34.

(7) The compression method of the second compressor 62 is of a dynamic type. This allows for the compression and discharge of a larger amount of second refrigerant while using a more compact compressor, as compared to, for example, a case in which the compression method of the second compressor 62 is of a displacement type.

### Modifications

The above-described embodiment may be modified as follows. The above-described embodiment and the following modifications can be combined as long as the combined modifications remain technically consistent with each other.

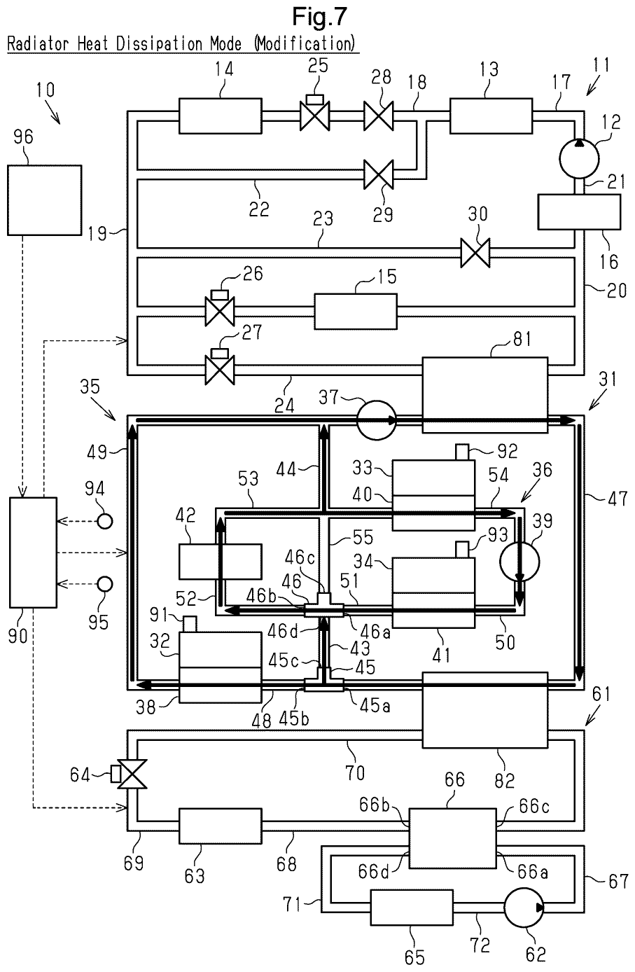

As shown in FIG. 7, in the radiator heat dissipation mode, for example, the controller 90 may control the operation of the second switching valve 46 to open the fourth port 46a and the fifth port 46b and close the sixth port 46c. Additionally, the second pump 39 may be driven under the control of the controller 90. Thus, in the radiator heat dissipation mode, the first switching valve 45 may be configured to connect to the radiator 42 and also connect to the second pump 39, the inverter heat exchanger 40, and the motor heat exchanger 41 in the permitted state. Further, in the second circulation circuit 36 during the radiator heat dissipation mode, coolant may sequentially flow through the inverter heat exchanger 40, the thirteenth pipe 54, the ninth pipe 50, the motor heat exchanger 41, and the tenth pipe 51. In this case, during the radiator heat dissipation mode, the coolant that has absorbed heat from the battery 32, as well as the coolant that has absorbed heat from the inverter 33 and the motor generator 34, dissipates heat at the radiator 42.

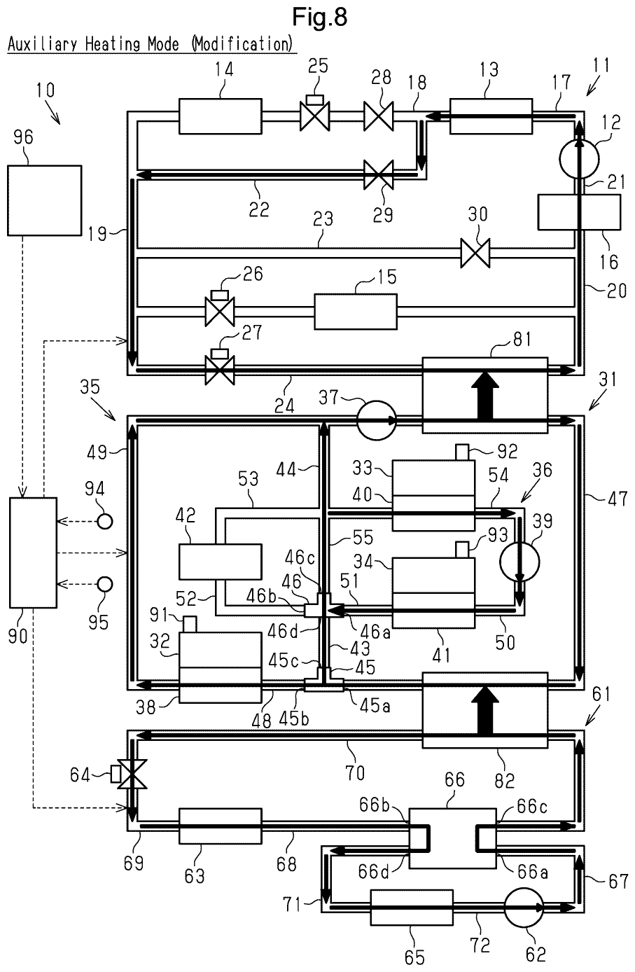

As shown in FIG. 8, when the auxiliary heating mode is executed, the battery 32 may be warmed up in the thermal medium circuit 31. Further, as in the embodiment of FIG. 8, the coolant that has absorbed heat from the motor generator 34 at the motor heat exchanger 41 and has absorbed heat from the inverter 33 at the inverter heat exchanger 40 may dissipate heat to the first refrigerant at the first heat exchanger 81. This configuration allows the heat generated by the motor generator 34 and the inverter 33 to be used as heat for heating purposes. Thus, the heating capacity of the passenger compartment is further improved.

In the embodiment, when the battery cooling mode is executed, the second pump 39 does not have to be operating. That is, when the battery cooling mode is executed, coolant does not have to circulate through the second circulation circuit 36, and the inverter 33 and the motor generator 34 do not have to be cooled.

In the embodiment, when the battery cooling mode is executed, the vehicle thermal management system 10 may be configured such that the coolant that has absorbed heat from the battery 32 does not dissipate heat to the first refrigerant at the first heat exchanger 81 in the thermal medium circuit 31. In this case, the first compressor 12 does not have to be operating in the battery cooling mode. Therefore, when the battery cooling mode is executed, the first refrigerant circuit 11 does not have to be operating, and the passenger compartment does not have to be conditioned by the first refrigerant circuit 11.

In the embodiment, when the battery cooling mode is executed, the vehicle thermal management system 10 may be configured such that the coolant that has absorbed heat from the battery 32 does not dissipate heat to the first refrigerant at the first heat exchanger 81 in the thermal medium circuit 31. In this case, for example, the first refrigerant circuit 11 may be executing the cooling mode.

In the embodiment, when the battery cooling mode is executed, the controller 90 may control the operation of the first switching valve 45 to open the first port 45a, the second port 45b, and the third port 45c. That is, when the battery cooling mode is executed, the first switching valve 45 may be switched to the permitted state. This allows the temperatures of the battery 32, the inverter 33, and the motor generator 34 to be regulated collectively.

In the embodiment, when the battery cooling mode is executed, the controller 90 may control the operation of the first switching valve 45 to open the first port 45a, the second port 45b, and the third port 45c. That is, when the battery cooling mode is executed, the first switching valve 45 may be switched to the permitted state. Further, the controller 90 may control the operation of the second switching valve 46 to open the fourth port 46a and the sixth port 46c and close the fifth port 46b. Thus, the thermal medium circuit 31 is configured such that the coolant that has received heat from the inverter 33 and the motor generator 34, in addition to the coolant that has absorbed heat from the battery 32, dissipates heat to the first refrigerant at the first heat exchanger 81.

In the embodiment, when the battery cooling mode is executed, the controller 90 may control the operation of the first switching valve 45 to open the first port 45a, the second port 45b, and the third port 45c. That is, when the battery cooling mode is executed, the first switching valve 45 may be switched to the permitted state. Further, the controller 90 may control the operation of the second switching valve 46 to, for example, open the fifth port 46b and close the fourth port 46a and sixth port 46c. Thus, when the battery cooling mode is executed, the vehicle thermal management system 10 may be set such that the coolant that has absorbed heat from the battery 32 at the battery heat exchanger 38 flows into the second circulation circuit 36 through the first connecting passage 43 and dissipates heat at the radiator 42.

In the embodiment, when the battery warm-up mode is executed, the second pump 39 does not have to be operating. That is, when the battery warm-up mode is executed, coolant does not have to circulate through the second circulation circuit 36, and the temperatures of the inverter 33 and the motor generator 34 do not have to be regulated.

In the embodiment, when the battery warm-up mode is executed, for example, the first refrigerant circuit 11 may be operated to execute either the cooling mode or the heating mode.

In the embodiment, when the battery warm-up mode is executed, the controller 90 may control the operation of the first switching valve 45 to open the first port 45a, the second port 45b, and the third port 45c. That is, when the battery warm-up mode is executed, the first switching valve 45 may be switched to the permitted state. This allows the temperatures of the battery 32, the inverter 33, and the motor generator 34 to be regulated collectively.

In the embodiment, the thermal medium circulating through the thermal medium circuit 31 is not limited to coolant. That is, any thermal medium circulating through the thermal medium circuit 31 may be used as long as it can regulate the temperatures of the battery 32, the inverter 33, and the motor generator 34.

1. A vehicle thermal management system, comprising:
a first refrigerant circuit configured such that a first refrigerant circulates through the first refrigerant circuit to condition a passenger compartment;
a thermal medium circuit configured such that a thermal medium circulates through the thermal medium circuit to regulate a temperature of a battery;
a second refrigerant circuit configured such that a second refrigerant circulates through the second refrigerant circuit to regulate a temperature of the thermal medium, the second refrigerant circuit including a compressor configured to compress and discharge the second refrigerant, an outside air heat exchanger configured to perform heat exchange between the second refrigerant and outside air, and an expansion valve configured to reduce a pressure of the second refrigerant;
a first heat exchanger coupled to the first refrigerant circuit and the thermal medium circuit and configured to perform heat exchange between the first refrigerant and the thermal medium;
a second heat exchanger coupled to the second refrigerant circuit and the thermal medium circuit and configured to perform heat exchange between the second refrigerant and the thermal medium; and
a controller configured to control operation of the first refrigerant circuit, the thermal medium circuit, and the second refrigerant circuit, wherein
the second refrigerant circuit includes a direction switching unit configured to switch between a first switching state and a second switching state under control of the controller, wherein the second refrigerant discharged from the compressor flows toward the outside air heat exchanger in the first switching state, and the second refrigerant discharged from the compressor flows toward the second heat exchanger in the second switching state, and
the controller is configured to switch an operating mode of the vehicle thermal management system between:
a battery cooling mode that switches the direction switching unit to the first switching state so that: the second refrigerant discharged from the compressor dissipates heat to the outside air at the outside air heat exchanger; after the heat dissipation, the second refrigerant is reduced in pressure by the expansion valve and absorbs heat from the thermal medium at the second heat exchanger, thereby cooling the thermal medium; and the cooled thermal medium absorbs heat from the battery to consequently cool the battery;
a battery warm-up mode that switches the direction switching unit to the second switching state so that: the second refrigerant discharged from the compressor dissipates heat to the thermal medium at the second heat exchanger; after the heat dissipation, the second refrigerant is reduced in pressure by the expansion valve and absorbs heat from the outside air at the outside air heat exchanger; and the heated thermal medium dissipates heat to the battery to consequently warm up the battery; and
an auxiliary heating mode that switches the direction switching unit to the second switching state so that: the second refrigerant discharged from the compressor dissipates heat to the thermal medium at the second heat exchanger to heat the thermal medium; and the heated thermal medium dissipates heat to the first refrigerant at the first heat exchanger to heat the first refrigerant, thereby consequently heating the passenger compartment.

2. The vehicle thermal management system according to claim 1, wherein
the thermal medium circuit is configured to regulate a temperature of a drive device that is powered by the battery in addition to regulating the temperature of the battery,
the thermal medium circuit includes:
a first circulation circuit that includes a first pump configured to circulate the thermal medium and a battery heat exchanger configured to perform heat exchange between the thermal medium and the battery, wherein the first heat exchanger is coupled to the second heat exchanger in the first circulation circuit; and
a second circulation circuit that includes a second pump configured to circulate the thermal medium, a drive device heat exchanger configured to perform heat exchange between the thermal medium and the drive device, and a radiator that dissipates heat from the thermal medium,
the first circulation circuit and the second circulation circuit are connected in parallel by a connecting passage, and
the thermal medium circuit includes a switching valve configured to switch between a permitted state and a blocked state under control of the controller, wherein connection between the first circulation circuit and the second circulation circuit through the connecting passage is permitted in the permitted state, and the connection between the first circulation circuit and the second circulation circuit through the connecting passage is blocked in the blocked state.

3. The vehicle thermal management system according to claim 1, wherein
the thermal medium circuit is configured such that the thermal medium that has absorbed heat from the battery dissipates heat to the first refrigerant at the first heat exchanger.

4. The vehicle thermal management system according to claim 2, wherein
the vehicle thermal management system is configured such that, by switching the switching valve to the permitted state, the thermal medium that has absorbed heat from the battery at the battery heat exchanger flows into the second circulation circuit through the connecting passage and dissipates heat at the radiator.

5. The vehicle thermal management system according to claim 2, wherein
the vehicle thermal management system is configured such that, by switching the switching valve to the permitted state, the thermal medium that has absorbed heat from the drive device at the drive device heat exchanger flows into the first circulation circuit through the connecting passage and dissipates heat to the battery at the battery heat exchanger.

6. The vehicle thermal management system according to claim 2, wherein
in at least one of the battery cooling mode or the battery warm-up mode, the controller switches the switching valve to the blocked state.

7. The vehicle thermal management system according to claim 1, wherein
a compression method of the compressor is of a dynamic type.
